(19) United States
(12) Patent Application Publication
(10) Pub. No.: US 2018/0159758 A1
(43) Pub. Date: Jun. 7, 2018

(54) VIRTUAL MEDIA ACCESS CONTROL ADDRESSES FOR HOSTS

(71) Applicant: Hewlett Packard Enterprise Development LP, Houston, TX (US)

(72) Inventor: Ariel Waizel, Petach Tikva (IL)

(21) Appl. No.: 15/366,324

(22) Filed: Dec. 1, 2016

(51) Int. Cl. H04L 12/751; H04L 29/12; H04L 12/741

(52) U.S. Cl. CPC H04L 45/02; H04L 45/74; H04L 61/20

(57) ABSTRACT

Examples described herein relate to virtual Media Access Control (MAC) addresses. In some such examples, a method includes receiving, at a first provider edge router, a discovery request for a MAC address of a first host communicatively coupled to the first provider edge router. The first provider edge router assigns a virtual Media Access Control (MAC) address to the first host. The virtual MAC address includes a host identifier of the first host. The virtual MAC address is provided from the first provider edge router to a second provider edge router for communication with the first host by a second host communicatively coupled to the second provider edge router.

### BACKGROUND

Networks carry data to and from computing devices nearly anywhere in the world, and to reach a given destination, data may flow across multiple heterogeneous networks. These networks may conform to different protocols and may utilize different packet formats, routing techniques, etc. Accordingly, edge devices such as edge routers may operate at the boundaries of these networks to convert data packets, when appropriate, to comply with the different network protocols.

For example, a customer may have a set of Local Area Networks (LANs) scattered over multiple sites. A service provider may join the customer networks via an intermediary provider network using a Software-Defined Wide Area Network (SD-WAN) service or other suitable technique. The service allows the customer LANs to exchange data as if they were a single network even though the LANs may conform to a first set of protocols while the provider may conform to a second set of protocols. In some examples, the flow of packets across the provider network may be transparent to both the sender and the recipient.

### BRIEF DESCRIPTION OF THE DRAWINGS

Certain examples are described in the following detailed description with reference to the drawings, of which:

FIG. 1 is a block diagram of a computing environment according to some examples of the present disclosure.

FIG. 2 is a flow diagram of a method of assigning a virtual address to a host according to some examples of the present disclosure.

FIGS. 3-4 are block diagrams of a computing environment performing a method of assigning a virtual address to a host according to some examples of the present disclosure.

FIG. 5 is a flow diagram of a method of assigning a virtual Media Access Control (MAC) address according to some examples of the present disclosure.

FIGS. 6-7 are block diagrams of a computing environment performing a method of assigning a virtual MAC address according to some examples of the present disclosure.

FIG. 8 is a memory diagram of a virtual MAC address according to some examples of the present disclosure.

FIG. 9 is a memory diagram of a virtual MAC translation table according to some examples of the present disclosure.

FIG. 10 is a memory diagram of a MAC routing table according to some examples of the present disclosure.

FIG. 11 is a flow diagram of a method of transmitting a data packet according to some examples of the present disclosure.

FIG. 12 is a block diagram of a computing environment performing a method of transmitting a data packet according to some examples of the present disclosure.

FIG. 13 is a block diagram of a provider edge router according to some examples of the present disclosure.

FIG. 14 is a block diagram of a provider edge router including a non-transitory computer-readable memory resource according to some examples of the present disclosure.

### DETAILED DESCRIPTION OF SPECIFIC EXAMPLES

Edge routers act to bridge networks and allow data to flow between them. The networks joined by an edge router may use different protocols for packet transmission, and for this reason and others, the edge router may modify data packets as they transition between networks. In some examples, a set of customer networks containing any number of hosts, routers, and Customer Edge (CE) routers are linked by a provider network according to a Software-Defined Wide Area Network (SD-WAN) service. Provider Edge (PE) routers perform packet tunneling across the provider network so that devices on a first customer network can communicate with devices on another customer network as if they were a single unitary network.

In some such examples, a sending host in a first customer network transmits data packets to a receiving host in a second customer network via the provider network. While switches in the first and second customer networks in these examples allow hosts to exchange layer 2 (L2) data packets, the provider network that joins the customer network may support layer 3 (L3) routing rather than L2 routing. Accordingly, when a first PE router receives an L2 data packet from the first customer network, it may encapsulate the L2 data packet in an L3 tunneling packet and route the L3 tunneling packet over the provider network to a second PE router coupled to the second customer network. The second PE router may decapsulate the L3 tunneling packet and forward the L2 data packet contained inside to the second host on the second customer network.

In order for the encapsulating PE router to properly address the L3 tunneling packet, the router may maintain a table that maps each host's L2 identifier (e.g., a Media Access Control (MAC) address) to an L3 identifier (e.g., an IP address) of a PE router coupled to the host's customer network. However, the number of hosts on the customer networks may be substantial. Accordingly, as an alternative to a MAC routing table with one entry per host MAC, in some examples, a virtual MAC address is substituted for the host's MAC in the table as well as in the L2 data packet. The virtual MAC address may include an identifier of the customer network to which the host is connected, and a particular customer network identifier may be shared across more than one host on the network. Therefore in these examples, a routing table mapping customer network identifiers to destination PE routers may be significantly smaller than a routing table mapping each host MAC. The smaller table in the encapsulating PE router may be take up less memory and may be faster to search.

At the other end of the communication, the decapsulating PE router may maintain a table that maps virtual MACs to their respective host MAC. This table may be used for address translation to replace a virtual MAC in a decapsulated data packet with the receiving host's MAC. In some examples, a virtual MAC includes a host identifier that is a pointer to a corresponding entry in the table to improve search performance. Furthermore, in some examples, the host identifier is selected to provide a unique virtual MAC for each host. This may improve compatibility with programs such as network analysis and monitoring programs that rely on each host reporting a unique address.

Many examples in the present disclosure provide an improved technique for joining customer networks. In some such examples, the technique addresses a host device using a virtual MAC address that includes a customer network identifier. Because the customer network identifiers may be shared across multiple hosts, a routing table for customer network identifiers may be significantly smaller than a routing table for MAC addresses. This may improve the table lookup performance and reduce the routing table's memory footprint in the PE router. In some examples, the virtual MAC address also includes a host identifier. The host identifier may be selected to produce a unique virtual MAC address for each host for compatibility. Furthermore, in some such examples, the host identifier includes a pointer to an entry in a translation table used to convert the virtual MAC address to a corresponding host MAC address. The pointer may reduce translation table lookup time. In these examples and others, the present disclosure provides substantial, real world improvements to the operation of a computing system, particularly to the manner in which data is transferred in a multiple network environment. In these ways and others, the technique herein materially improves computer network operation.

These examples and others are described with reference to the following figures. Unless noted otherwise, the figures and their accompanying description are non-limiting, and no element is characteristic of any particular example. In that regard, features from one example may be freely incorporated into other examples without departing from the spirit and scope of the disclosure.

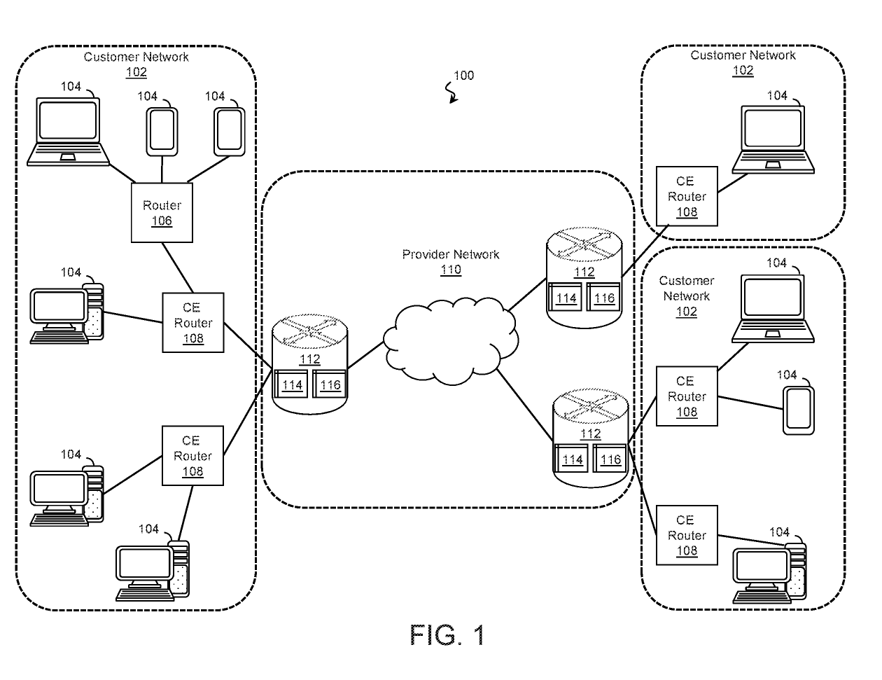

A computing environment for practicing the technique is described with reference to FIG. 1. In that regard, FIG. 1 is a block diagram of a computing environment 100 according to some examples of the present disclosure. The computing environment 100 includes a number of customer networks 102 of any size and configuration, such as Local Area Networks (LANs), Wide Area Networks (WANs), Metropolitan Area Networks (MANs), etc. Each customer network 102 may include a combination of computing and/or networking entities. Suitable computing entities include the illustrated hosts 104. While illustrated as a single entity, each host 104 may include a single unitary computing device, a cluster of discrete computing devices, or any permutation thereof, and in various examples, hosts 104 take various forms including servers, desktop computers, laptop computers, tablets, smartphones, cellular phones, other portable devices, and/or other suitable forms.

The hosts 104 of a customer network 102 may be communicatively coupled by routing devices 106 (e.g., routers, switches, hubs, gateways, etc.) that route any suitable type of packet through the customer network 102 according to any suitable network protocol. For example, the routing devices 106 may support L2 switching and may route L2 data packets that specify a destination using a MAC address associated with the receiving host 104. One particular type of routing device 106 is a Customer Edge (CE) router 108, which may route data packets within the customer network 102 and may also route data packets between the customer network 102 and a provider network 110.

The provider network 110 carries data packets between the customer networks 102 and may do so in such a manner that the separate customer networks 102 appear to be a single customer network 102 from the perspective of the hosts 104, the routing devices 106, and/or the CE routers 108. However, the provider network 110 may be shared between multiple customers and may be structured differently than the customer networks 102 for security, performance, fault tolerance, and/or other reasons. In various examples, the provider network 110 includes an IP-based L3 network (IPv4 and/or IPv6) and/or a point-to-point protocol (PPP) network, and routing devices in the provider network 110 may route data packets accordingly.

To bridge the disparate networks, the provider network 110 may include PE routers 112 communicatively coupled to the customer networks 102 via the CE routers 108. The PE routers 112 may route data packets within the provider network 110 and may also route data packets between the provider network 110 and the customer networks 102.

When routing a packet between networks, a PE router 112 may modify the packet to make it suitable for transmission over the destination network. In some examples, this includes the PE router 112 encapsulating a first data packet (e.g., a data packet received from a customer network 102) in the payload of a second data packet (e.g., a data packet for transmission over the provider network 110). In an example of this, a PE router 112 receives an L2 data packet from a first host 104 on a first customer network 102 that is addressed to the MAC address of a second host 104 on a second customer network 102. The PE router 112 encapsulates the L2 data packet in an L3-based tunneling packet for transmission on the provider network 110. To send the L3 tunneling packet to the correct device, the encapsulating PE router may address the L3 tunneling packet to another PE router 112 that is communicatively coupled to the second customer network 102.

To determine an address for the destination PE router 112, the encapsulating PE router 112 may maintain a MAC routing table 114 that associates MAC addresses for hosts 104 with a corresponding PE router 112 that is communicatively coupled to the host's customer network 102. In some examples, the MAC routing table 114 includes an entry for each host 104 and each MAC address within all of the customer networks 102. However because the number of hosts 104 in the customer networks 102 may number in the millions, in some examples, virtual MAC addresses are substituted for host MAC addresses. The virtual MAC addresses may include a customer network identifier that is shared with some or all of the hosts 104 on a given customer network 102. By using the customer network identifier in the MAC routing table 114, the size of the MAC routing table 114 may be greatly reduced.

In addition to the MAC routing table 114, each PE router 112 may include a virtual MAC translation table 116 that maps virtual MAC addresses to their corresponding host MAC address. Because the virtual MAC translation table 116 may be limited to those hosts 104 local to the respective PE router 112, the total size of the tables (e.g., the MAC routing table 114 and the virtual MAC translation table 116) may be significantly smaller than examples that use a single monolithic table with a routing entry for each host 104. This may reduce the memory allocated to the tables and the table lookup latencies, providing a faster and more affordable PE router 112.

When the tunneling packet arrives at the destination PE router 112, it may be decapsulated to extract the L2 data packet from the payload. The destination PE router 112 may replace the virtual MAC address in the data packet with the MAC address for the receiving host 104 using the virtual MAC translation table 116. In some examples, each virtual MAC address includes a host identifier with a pointer to a table entry to assists the destination PE router 112 in locating the entry in the virtual MAC translation table 116. In some such examples, the host identifier in the virtual MAC address ensures that each host 104 has a unique virtual MAC address. Many software tools, including network analysis tools, rely on each host 104 reporting a unique MAC address, whether virtual or real, and assigning each host a unique virtual MAC address may ensure compatibility with such tools.

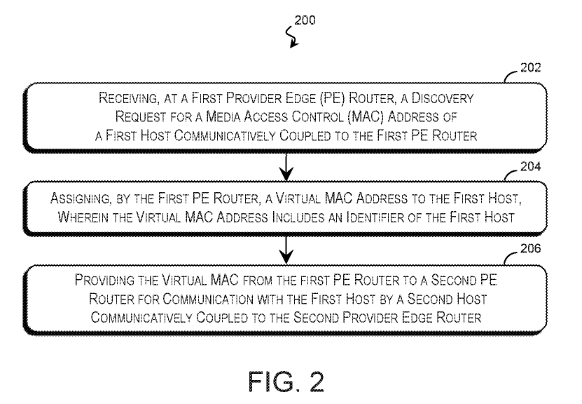

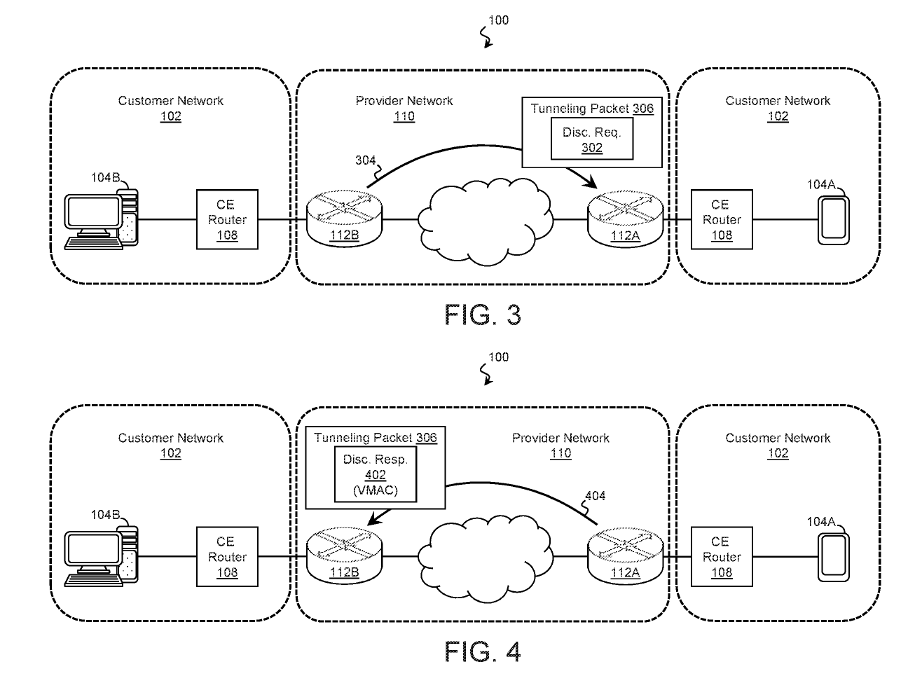

Examples of the technique for assigning virtual MAC addresses to hosts 104 are described in further detail with reference to FIGS. 2-4. FIG. 2 is a flow diagram of a method 200 of assigning a virtual address to a host according to some examples of the present disclosure. The description of the method 200 is non-limiting, and steps may be added to and omitted from the method 200 without departing from the disclosure. Furthermore, unless noted otherwise, processes of the method 200 may be performed in any order including being performed concurrently by one or more entities. FIGS. 3-4 are block diagrams of a computing environment 100 performing the method 200 according to some examples of the present disclosure. In many aspects, the computing environment 100 may be substantially similar to the computing environment of FIG. 1. For example, the customer networks 102, the hosts 104 (including hosts 104A and 104B), the CE routers 108, the provider network 110, and the PE routers 112 (including PE routers 112A and 112B) may each be substantially similar to those described above.

Referring first to block 202 of FIG. 2 and to FIG. 3, a first PE router 112A receives a discovery request 302 for a MAC address of a first host (e.g., host 104A) communicatively coupled to the first PE router 112A. The discovery request 302 may be received from a second PE router 1126 over the provider network 110 as indicted by arrow 304 and may take any suitable form supported by the provider network 110. In various examples, the discovery request 302 is an Address Resolution Protocol (ARP) discovery request and/or an IPv6 neighbor solicitation request. The first PE router 112A may encapsulate the discovery request 302 in a payload of a tunneling packet 306 for transmission over the provider network 110.

Referring to block 204, the first PE router 112A assigns a virtual MAC address to the first host 104A in response to the discovery request 302. The virtual MAC address may include various identifiers such as an identifier of the first host 104A.

Referring to block 206 of FIG. 2 and to FIG. 4, the first PE router 112A provides a discovery response 402 that includes the virtual MAC address to the second PE router 1126 over the provider network 110 as indicated by arrow 404. As with the discovery request 302, the discovery response 402 may be encapsulated in a payload of a tunneling packet 306 for transmission over the provider network 110. In some such examples, the discovery response 402 is extracted from the tunneling packet 306 by the second PE router 112B before providing the discovery response 402 (and the virtual MAC) to a second host (e.g., host 104B) coupled to the second PE router 112B. In this way, the virtual MAC address may be used by the second host 1046 to address data packets to the first host 104A.

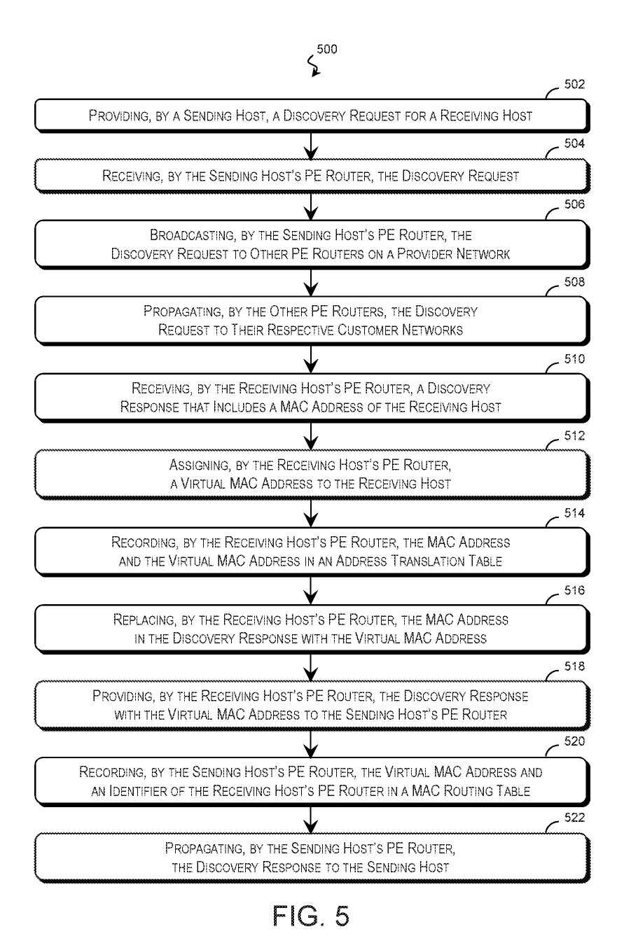

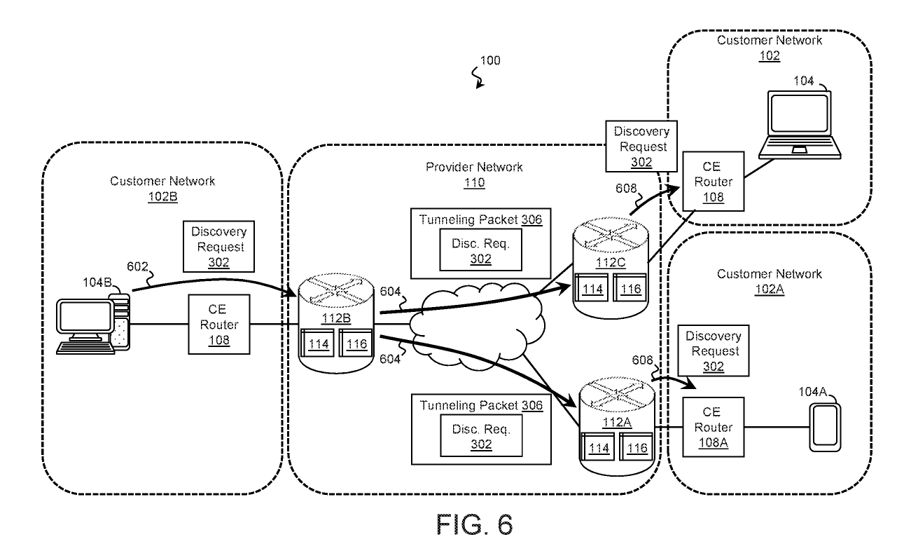

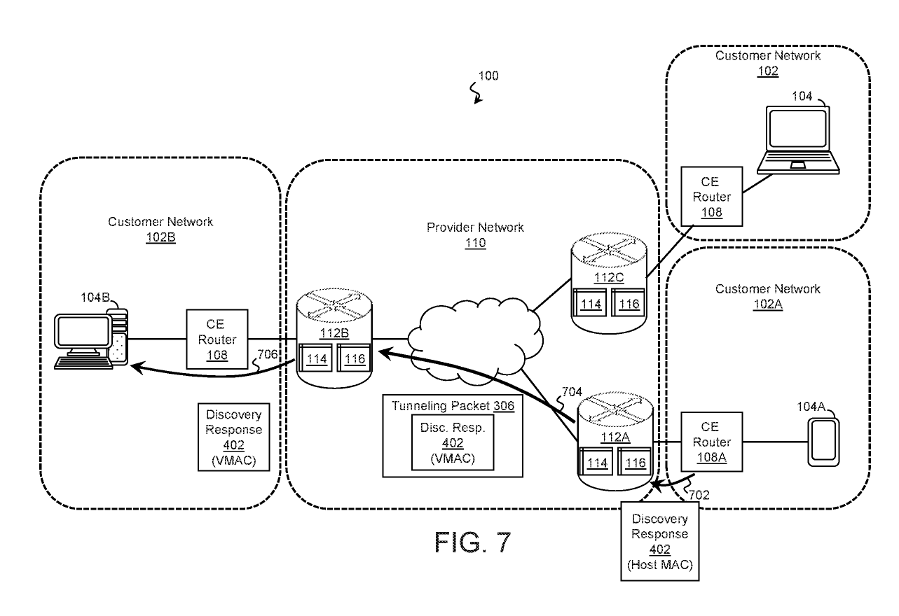

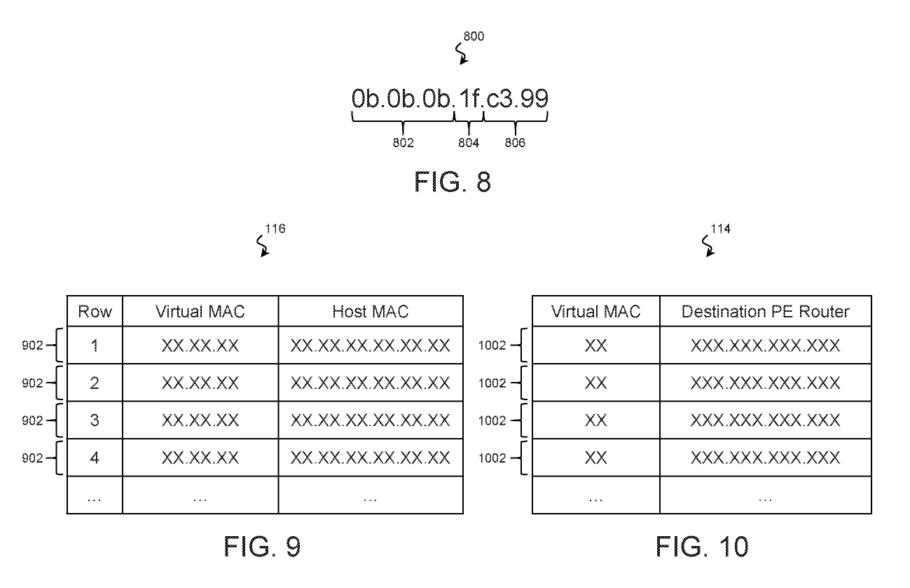

Further examples are described in further detail with reference to FIGS. 5-10. FIG. 5 is a flow diagram of a method 500 of assigning a virtual MAC address according to some examples of the present disclosure. The description of the method 500 is non-limiting, and steps may be added to and omitted from the method 500 without departing from the disclosure. Furthermore, unless noted otherwise, processes of the method 500 may be performed in any order including being performed concurrently by one or more entities. FIGS. 6-7 are block diagrams of a computing environment 100 performing the method 500 according to some examples of the present disclosure. In many aspects, the computing environment 100 may be substantially similar to the computing environment 100 of FIGS. 1, 3 and/or 4. For example, the customer networks 102 (including customer networks 102A and 102B), the hosts 104 (including hosts 104A and 104B), the CE routers 108, the provider network 110, and the PE routers 112 (including PE routers 112A, 112B, and 112C) may be substantially similar to those described above. FIG. 8 is a memory diagram of a virtual MAC address 800 according to some examples of the present disclosure. FIG. 9 is a memory diagram of a virtual MAC translation table 116 according to some examples of the present disclosure. FIG. 10 is a memory diagram of a MAC routing table 114 according to some examples of the present disclosure.

In the examples of FIGS. 5-10, a sending host 104B on a customer network 102B intends to transmit data to a receiving host 104A on another customer network 102A. To do so, the sending host 104B first requests an address for the receiving host 104A. Referring to block 502 of FIG. 5 and to FIG. 6, the sending host 104B provides a discovery request 302 on the sending host's customer network 102B as indicated by arrow 602. The discovery request 302 may request any suitable identifier of the receiving host 104A such as the MAC address of the receiving host 104A, and may refer to the receiving host 104A by any known identifier, such as an IP address or other suitable identifier. In various examples, the discovery request takes any suitable form, such as an ARP discovery request and/or an IPv6 neighbor solicitation request.

Because in the example, the receiving host 104A is not part of the sending host's customer network 102B, the discovery request 302 is propagated to a PE router 112B communicatively coupled to the sending host's customer network 102B. In that regard, the discovery request 302 is received by the sending host's PE router 112B as shown in block 504 of FIG. 5.

Referring to block 506 of FIG. 5, the sending host's PE router 112B broadcasts the discovery request 302 throughout the provider network 110 to other PE devices, including PE routers 112A and 112C, as indicated by arrows 604. The broadcasting of the discovery request 302 by PE router 112B and the receiving of the discovery request 302 by PE routers 112A and 112C may be performed substantially as described in block 202 of FIG. 2. In some such examples, PE router 112B broadcasts the discovery request by encapsulating the discovery request 302 in a payload of a tunneling packet 306 and transmits a copy of the tunneling packet 306 to each of the other PE routers 112A and 112C.

In turn, the PE routers 112A and 112C that receive the device discovery request 302 propagate the request to their respective customer networks 102 as indicated by arrows 606 and shown in block 508. In examples where the discovery request 302 is included in a tunneling packet 306, the discovery request may be extracted therefrom by the receiving PE router 112.

Referring to block 510 of FIG. 5 and to FIG. 7, one of the PE routers (e.g., PE router 112A) receives a response to the device discovery request 302 as indicated by arrow 702. The discovery response 402 may include an identifier (such as a MAC address) of the receiving host 104A, and may be provided by the receiving host 104A itself or by an intermediary device, such as a CE router 108A communicatively coupled between the receiving host 104A and the PE router 112A. In contrast, PE router 112C may not receive a response to the device discovery request 302 if the request does not match a host 104 of this PE router's customer network 102.

Referring to block 512 of FIG. 5, the receiving host's PE router 112A assigns the receiving host 104B a virtual MAC address. This may be performed substantially as described in block 204 of FIG. 2. The virtual MAC address 800 may take any suitable form, examples of which are described with reference to FIG. 8. The virtual MAC address 800 may encode a number of identifiers. In some examples, the virtual MAC address 800 includes an organizationally unique identifier 802. The organizationally unique identifier 802 of the virtual MAC address 800 may be set to a reserved value that indicates to the PE routers 112 that the virtual MAC address 800 is a virtual address. This may be used to detect a virtual MAC address and may avoid the PE routers 112 attempting to convert non-virtual MAC addresses.

In some examples, the virtual MAC address 800 includes a customer network identifier 804. The customer network identifier 804 may identify the customer network 102A to which the receiving host 104A is communicatively coupled by any suitable identifier, and in some examples, the customer network identifier 804 includes an identifier of a CE router 108 on the customer network 102 to which the receiving host 104A is coupled. For example, in FIG. 7, the receiving host 104A is coupled to the PE router 112A by CE router 108A. Accordingly, in the example, the customer network identifier 804 in the virtual MAC address 800 for the receiving host 104A includes an identifier of the CE router 108A.

In some examples, the virtual MAC address 800 includes a host identifier 806 corresponding to the receiving host 104A. The host identifier 806 may include a pointer (e.g., a row pointer, MAC address hash, etc.) to an entry in the virtual MAC translation table 116 that records the virtual MAC address 800 and the respective host MAC address. This may help the PE router 112 find the relevant entry faster. In some examples, the host identifier 806 is selected such that each virtual MAC address 800 for each host 104 in the computing environment 100 is unique. This may promote compatibility with tools that rely on each host 104 reporting a unique MAC address.

Referring to block 514 of FIG. 5 and to FIG. 9, the receiving host's PE router 112A records the virtual MAC address 800 and the receiving host's MAC address in a virtual MAC translation table 116. The virtual MAC translation table 116 maps virtual MAC addresses to their corresponding host MAC address for each host 104 that is local to the PE router 112 (e.g., on the customer network 102 that the PE router 112 is coupled to). The virtual MAC translation table 116 may be represented as an array, a hash table, a tree, a linked list, and/or other suitable data structure. In an example, the virtual MAC translation table 116 includes a set of entries 902. Each entry 902 records a MAC address, a corresponding virtual MAC address, and/or hashes thereof, and parts of the MAC address and/or virtual MAC address may be omitted, such as the organizationally unique identifier 802. The entries 902 of the virtual MAC translation table 116 may also include a row number or entry identifier that may be used in conjunction with the host identifier 806 of the virtual MAC address 800 to locate a particular entry 902.

Referring to block 516 of FIG. 5, the receiving host's PE router 112A replaces the receiving host's MAC address in the discovery response 402 with the virtual MAC address 800. Referring to block 518 of FIG. 5 and referring back to FIG. 7, the receiving host's PE router 112A provides the discovery response 402 that includes the virtual MAC address 800 to the sending host's PE router 1126 as indicated by arrow 704. This may be performed substantially as described in block 206 of FIG. 2, and in some examples, the receiving host's PE router 112A encapsulates the discovery request 302 in a payload of a tunneling packet 306 for transmission over the provider network 110.

Referring to block 520 of FIG. 5 and to FIG. 10, the sending host's PE router 1126 records, in a MAC routing table 114, a portion of the virtual MAC address 800 and an identifier (e.g., an IP address) of the receiving host's PE router 112A. As with the virtual MAC translation table 116, the MAC routing table 114 may be represented as an array, a hash table, a tree, a linked list, and/or other suitable data structure, and may include a set of entries 1002. In some examples, each entry 1002 in the MAC routing table 114 stores the customer network identifier 804 of a virtual MAC address 800 and an identifier of a corresponding PE router 112 communicatively coupled to the respective customer network 102. In this way, the sending host's PE router 112B may use the receiving host's PE router 112A as a destination for tunneling data packets addressed to the receiving host's virtual MAC address 800. The sending host's PE router 112B may also use the receiving host's PE router 112A as a destination for tunneling data packets addressed to any other host 104 that shares the same customer network identifier 804.

Referring to block 522 of FIG. 5 and referring back to FIG. 7, the sending host's PE router 112B propagates the discovery response 402 that includes the virtual MAC address 800 to the sending host 104B as indicated by arrow 706. The sending host 1046 may now use the virtual MAC address 800 in order to send data packets to the receiving host 1046.

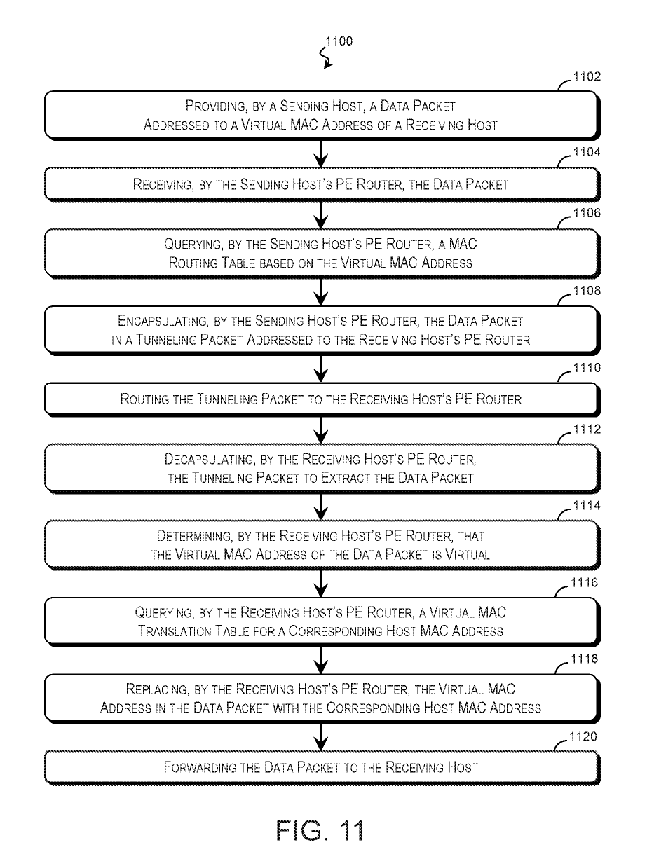

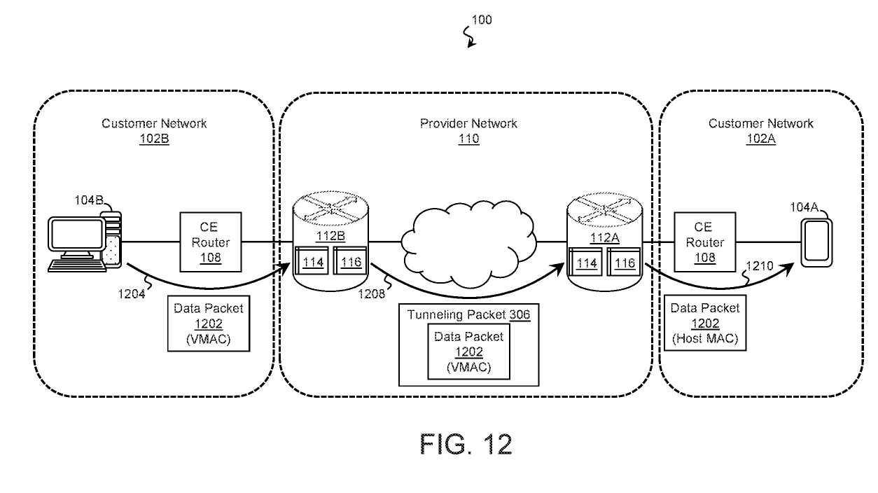

Examples of sending data packets using the virtual MAC address 800 are described in further detail with reference to FIGS. 11 and 12. FIG. 11 is a flow diagram of a method 1100 of transmitting a data packet according to some examples of the present disclosure. The description of the method 1100 is non-limiting, and steps may be added to and omitted from the method 1100 without departing from the disclosure. Furthermore, unless noted otherwise, processes of the method 1100 may be performed in any order including being performed concurrently by one or more entities. FIG. 12 is a block diagram of a computing environment 100 performing the method 1100 according to some examples of the present disclosure. In many aspects, the computing environment 100 may be substantially similar to the computing environment 100 of FIGS. 1, 3, 4, 6, and/or 7. For example, the customer networks 102 (including customer networks 102A and 102B), the hosts 104 (including hosts 104A and 104B), the CE routers 108, the provider network 110, and the PE routers 112 (including PE routers 112A, 112B, and 112C) may be substantially similar to those described above.

In the following examples, a sending host 104B on a customer network 102B intends to transmit data packets to a receiving host 104A on another customer network 102A using a virtual MAC address 800 assigned via method 200, method 500, and/or other suitable technique. Referring to block 1102 of FIG. 11 and to FIG. 12, the sending host 104B provides a data packet 1202 addressed to the receiving host 104A to the customer network 102B as indicated by arrow 1204. The data packet 1202 may take any suitable form, and in some examples, the data packet 1202 is an L2 data packet and refers to the receiving host 104A using a virtual MAC address 800, such as the one assigned in method 200 and/or method 500. In an example, because the receiving host 104A is not on the same customer network 102B as the sending host 104B, the data packet 1202 propagates to a PE router 112B that is communicatively coupled to the customer network 102B. The sending host's PE router 112B receives the data packet in block 1104.

The sending host's PE router 112B may create a tunnel through the provider network 110 to another PE router (e.g., PE router 112A) that is communicatively coupled to the receiving host 104A. Accordingly, referring to block 1106, the sending host's PE router 112B queries a MAC routing table 114 using an identifier in the virtual MAC address 800, such as the customer network identifier 804, to determine which PE router 112A is communicatively coupled to the receiving host 104A to use as a tunneling destination. Based on the results, the sending host's PE router 112B encapsulates the data packet 1202 in a payload of a tunneling packet 306 that is addressed to the receiving host's PE router 112A, as illustrated in block 1108.

The tunneling packet 306 may take any suitable form that is compatible with the provider network 110. In some examples, the provider network 110 supports IP routing (e.g., IPv4, IPv6, etc.), and the tunneling packet 306 is a corresponding IP packet. In some examples, the provider network 110 is a point-to-point protocol network and the tunneling packet 306 is a point-to-point tunneling packet.

Referring to block 1110 of FIG. 11 and to FIG. 12, the sending host's PE router 1126 routes the tunneling packet 306 over the provider network 110 to the receiving host's PE router 112A determined in block 1106 as represented by arrow 1208. Upon receiving the tunneling packet 306, the receiving host's PE router 112A decapsulates the tunneling packet 306 by extracting the data packet 1202 from the payload as illustrated in block 1112 of FIG. 11.

At this point, the data packet 1202 may be still addressed to the virtual MAC address 800 assigned to the receiving host 104. Accordingly, in block 1114, the receiving host's PE router 112A determines from the organizationally unique identifier 802 or other suitable attribute of the virtual MAC address 800 that it is a virtual address. In block 1116, the receiving host's PE router 112A performs a lookup in a virtual MAC translation table 116 to find a corresponding MAC address. In some examples, the lookup may be simplified using a pointer to a table entry 902 within the host identifier 806 of the virtual MAC address 800.

Referring to block 1118, the receiving host's PE router 112A replaces the virtual MAC address in the data packet 1202 with the receiving host's MAC address from block 1116. The PE router 112A forwards the data packet containing the host's MAC address to the receiving host 104A via the customer network 102A in block 1120 as represented by arrow 1210. In some examples where the virtual MAC address specifies a CE router 108A that couples the receiving host 104A to the PE router 112A, the PE router 112A provides the data packet 1202 to the specified CE router 108A for forwarding to the receiving host 104A.

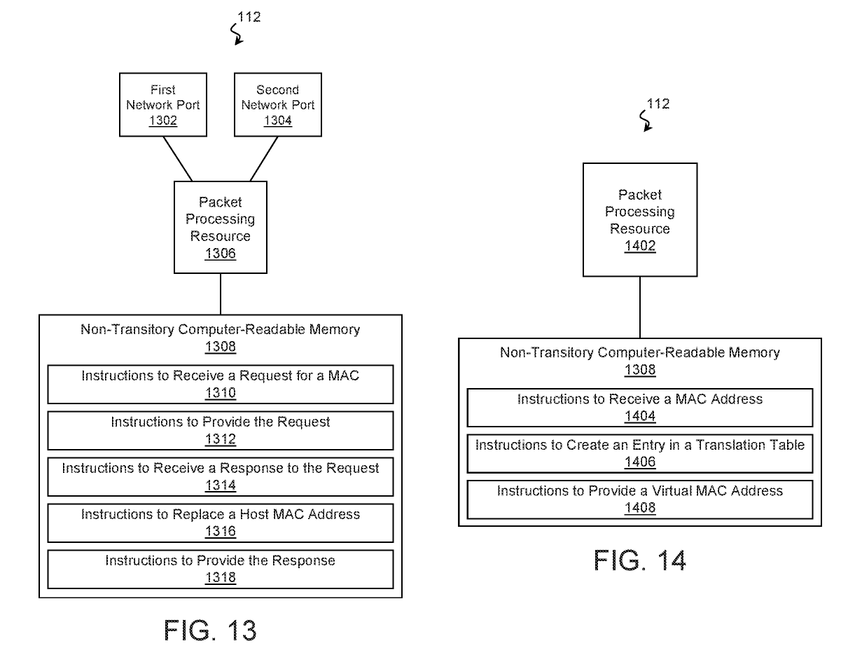

Examples of the PE routers 112 that perform the processes of method 200, 500, and/or 1100 are described in further detail in the context of FIG. 13. In that regard, FIG. 13 is a block diagram of a PE router 112 according to some examples of the present disclosure. The PE router 112 is suitable for use as the PE router 112 in the examples of FIGS. 1, 3, 4, 6, 7, and 12 and may perform any of the processes of FIGS. 2, 5, and 11.

The PE router 112 may include a first network port 1302 to communicatively couple to a provider network 110 and a second network port 1304 to communicatively couple to a customer network 102. The first network port 1302 and the second network port 1304 may conform to any suitable physical layer (PHY) configuration such as: Ethernet, coaxial, Ethernet-over-power, other conductor configurations, fiber optic, IrDA, other optical configurations, Wi-Fi, other wireless configurations, and/or other suitable PHY configurations.

The first and second network ports 1302 and 1304 may be in communication with and controlled by a packet processing resource 1306 that includes any number and combination of CPUs, GPUs, microcontrollers, ASICs, FPGAs, and/or other processing resources. The packet processing resource 1306 may be coupled to a non-transitory computer-readable memory resource 1308. The non-transitory computer-readable memory resource 1308 may include any number of non-transitory memory devices including battery-backed RAM, SSDs, HDDs, optical media, and/or other memory devices suitable for storing instructions. Accordingly, in various examples, the non-transitory computer-readable memory resource 1308 stores instructions for performing processes of method 200, method 500 and/or method 1100.

For example, referring to block 1310, the non-transitory computer-readable memory resource 1308 may store instructions that cause the packet processing resource 1306 to receive a request for a MAC address of a host 104 at the first network port 1302. This may be performed substantially as described in block 202 of FIG. 2 and/or block 506 of FIG. 5.

Referring to block 1312, the non-transitory computer-readable memory resource 1308 may store instructions that cause the packet processing resource 1306 to provide the request to the customer network 102 via the second network port 1304. This may be performed substantially as described in block 508 of FIG. 5.

Referring to block 1314, the non-transitory computer-readable memory resource 1308 may store instructions that cause the packet processing resource 1306 to receive a response to the request. The response may be received from the customer network 102 via the second network port 1304 and may include the MAC address of the host 104. This may be performed substantially as described in block 510 of FIG. 5.

Referring to block 1316, the non-transitory computer-readable memory resource 1308 may store instructions that cause the packet processing resource 1306 to replace the MAC address of the host 104 in the response with a virtual MAC address 800 that includes an identifier of the host 104. This may be performed substantially as described in block 516 of FIG. 5.

Referring to block 1318, the non-transitory computer-readable memory resource 1308 may store instructions that cause the packet processing resource 1306 to provide the response that includes the virtual MAC address 800 via the first network port 1302. This may be performed substantially as described in block 206 of FIG. 2 and/or block 518 of FIG. 5.

Further examples of a suitable PE router 112 to perform the processes of method 200, 500, and/or 1100 are described in further detail in the context of FIG. 14. In that regard, FIG. 14 is a block diagram of a PE router 112 including a non-transitory computer-readable memory resource according to some examples of the present disclosure. The PE router 112 is suitable for use in the examples of FIGS. 1, 3, 4, 6, 7, and 12 and may perform any of the processes of FIGS. 2, 5, and/or 11.

The processes of methods 200, 500, and/or 1100 may be performed by any combination of hard-coded and programmable logic in the PE router 112. In some examples, the PE router 112 includes a processing resource 1402. The processing resource 1402 may be substantially similar to the packet processing resource 1306 of FIG. 13 and may include any number and combination of CPUs, GPUs, microcontrollers, ASICs, FPGAs, and/or other processing resources. The processing resource 1402 may utilize instructions stored on a non-transitory computer-readable memory resource 1308 to perform at least some of these processes. Accordingly, examples of the present disclosure may take the form of a non-transitory computer-readable memory resource 1308 storing instructions that perform at least part of methods 200, 500, and/or 1100, examples of which follow.

Referring to block 1404, the non-transitory computer-readable memory resource 1308 may store instructions that cause the packet processing resource 1306 to receive a MAC address associated with a host 104. This may be performed substantially as described in block 510 of FIG. 5.

Referring to block 1406, the non-transitory computer-readable memory resource 1308 may store instructions that cause the packet processing resource 1306 to create an entry 902 in a virtual MAC translation table 116 corresponding the MAC address of the host 104 to a virtual MAC address 800. In some examples, the virtual MAC address 800 includes a host identifier 806 of the host 104. This may be performed substantially as described in block 204 of FIG. 2 and/or blocks 512-514 of FIG. 5.

Referring to block 1408, the non-transitory computer-readable memory resource 1308 may store instructions that cause the packet processing resource 1306 to provide the virtual MAC address 800 to a another PE router 112 for use in communicating data packets to the host 104 across a provider network 110. This may be performed substantially as described in block 206 of FIG. 2 and/or blocks 516-518 of FIG. 5.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, at a first provider edge router, a discovery request for a Media Access Control (MAC) address of a first host communicatively coupled to the first provider edge router;
assigning, by the first provider edge router, a virtual MAC address to the first host, wherein the virtual MAC address includes a host identifier of the first host; and
providing the virtual MAC address from the first provider edge router to a second provider edge router for communication with the first host by a second host communicatively coupled to the second provider edge router.

2. The method of claim 1, wherein the virtual MAC address includes a network identifier that is shared among a plurality of hosts communicatively coupled to the first provider edge router.

3. The method of claim 1, wherein the first provider edge router is communicatively coupled to the first host by a customer edge router, and wherein the network identifier of the virtual MAC address includes an identifier of the customer edge router.

4. The method of claim 1, wherein the assigning of the virtual MAC address includes adding an entry to a virtual MAC translation table, and wherein the host identifier includes a pointer to the entry in the virtual MAC translation table.

5. The method of claim 1, wherein the virtual MAC address includes an organizationally unique identifier, and wherein the organizationally unique identifier identifies the virtual MAC address as a virtual address.

6. The method of claim 1, wherein the assigning of the virtual MAC address includes:
providing the discovery request to a customer edge router that communicatively couples the first provider edge router to the first host;
receiving a discovery response at the first provider edge router from the customer edge router, wherein the discovery response includes a MAC address of the first host;
replacing the MAC address of the first host in the discovery response with the virtual MAC address; and
providing the discovery response containing the virtual MAC address to the second provider edge router.

7. The method of claim 1, wherein the discovery request is from a group consisting of: an address resolution protocol discovery request and an IPv6 neighbor solicitation request.

8. The method of claim 1 comprising:
receiving, at the first provider edge router, a tunneling data packet including an encapsulated data packet that contains the virtual MAC address;
determining, by the first provider edge router, that the virtual MAC address is associated with the first host;
replacing, by the first provider edge router, the virtual MAC address in the encapsulated data packet with the MAC address of the first host; and
providing the encapsulated data packet containing the MAC address of the first host to the first host.

9. The method of claim 8, wherein the tunneling data packet is from a group consisting of: an IPv4 data packet, an IPv6 data packet, and a point-to-point protocol data packet.

10. A device comprising:
a first network port to communicatively couple to a provider network;
a second network port to communicatively couple to a customer network;
a packet processing resource in communication with the first network port and the second network port; and
a non-transitory computer-readable memory resource that stores instructions that, when executed, cause the packet processing resource to:
receive a request for a Media Access Control (MAC) address of a host on the customer network at the first network port;
provide the request to the customer network via the second network port;
receive a response to the request from the customer network that includes the MAC address of the host;
replace the MAC address of the host in the response with a virtual MAC address that includes an identifier of the host; and
provide the response that includes the virtual MAC address to the provider network via the first network port.

11. The device of claim 10, wherein the virtual MAC address includes an identifier of a customer edge router that communicatively couples the host to the device.

12. The device of claim 10, wherein the virtual MAC address includes an organizationally unique identifier that identifies the virtual MAC address as virtual.

13. The device of claim 10 comprising an address translation table, wherein the non-transitory computer-readable memory resource stores instructions that cause the packet processing resource to create an entry in the address translation table that associates the virtual MAC address with the MAC address of the host.

14. The device of claim 13, wherein the virtual MAC address includes a pointer to the entry in the address translation table that associates the virtual MAC address with the MAC address of the host.

15. The device of claim 10, wherein the non-transitory computer-readable memory resource stores instructions that cause the packet processing resource to:
receive a tunneling data packet at the first network port that includes an encapsulated data packet;
determine that the encapsulated data packet includes the virtual MAC address;
determine from the identifier of the host in the virtual MAC address that the encapsulated data packet is directed to the host;
replace the virtual MAC address in the encapsulated data packet with the MAC address of the host; and
provide the encapsulated data packet that includes the MAC address of the host to the host via the second network port.

16. A non-transitory computer-readable memory resource storing instructions that, when executed, cause a processing resource to:
receive a Media Access Control (MAC) address associated with a host;
create an entry in an address translation table corresponding the MAC address of the host to a virtual MAC address, wherein the virtual MAC address includes an identifier of the host;
provide the virtual MAC address to a provider edge router for use in communicating data packets to the host across a provider network.

17. The non-transitory computer-readable memory resource of claim 16 storing instructions that cause the processing resource to receive the MAC address via a customer edge router, wherein the virtual MAC address includes an identifier of the customer edge router.

18. The non-transitory computer-readable memory resource of claim 16, wherein the identifier of the host in the virtual MAC address includes a pointer to the entry in the address translation table.

19. The non-transitory computer-readable memory resource of claim 16 storing instructions that cause the processing resource to:
receive a tunneling data packet with an encapsulated data packet containing the virtual MAC address;
identify the entry in the address translation table from the virtual MAC address;
determine from the entry that the encapsulated data packet is directed to the host; and
provide the encapsulated data packet to the host.

20. The non-transitory computer-readable memory resource of claim 19, wherein the instructions to provide the encapsulated data packet to the host include instructions that cause the processing resource to:
replace the virtual MAC address in the encapsulated data packet with the MAC address of the host; and
provide the encapsulated data packet including the MAC address of the host to a network to which the host is communicatively coupled.
